(19) United States
(12) Patent Application Publication
(10) Pub. No.: US 2026/0233718 A1
(43) Pub. Date: Aug. 13, 2026

(54) DYNAMIC BRAKE BIASING USING ELECTRO-MAGNETIC BRAKES FOR PASSENGER VEHICLES AND A METHOD FOR CONTROLLING THE BRAKES

(71) Applicant: AUMOVIO Systems, Inc., Auburn Hills, MI (US)

(72) Inventors: Nicholas Lee Mawhinney, Fenton, MI (US); Clinton L. Schumann L. Schumann, Holly, MI (US); Iulian-Nicolae Ungureanu, Lake Orion, MI (US)

(73) Assignee: AUMOVIO Systems, Inc., Auburn Hills, MI (US)

(21) Appl. No.: 19/531,258

(22) Filed: Feb. 5, 2026

Related U.S. Application Data
(60) Provisional application No. 63/755,936, filed on Feb. 7, 2025.

(51) Int. Cl. B60T 8/172; B60T 8/171; B60T 8/24

(52) U.S. Cl. CPC B60T 8/172; B60T 8/171; B60T 8/241; B60T 2220/04; B60T 2240/00; B60T 2250/03; B60T 2250/04

(57) ABSTRACT

A device and method of controlling vehicle brake system with a plurality of wheel brakes includes one or more processors configured to determine an application force for an actuator for each of the plurality of brakes and to control an actuator for each one of the plurality of brakes to selectively modulate the application force to a respective rotor of the one of the plurality of brakes, wherein the modulated application force is different from the application force to at least another rotor of the plurality of brakes to provide dynamic brake biasing to the one of the plurality of wheel brakes while ensuring adequate braking of the vehicle.

### CROSS REFERENCE TO RELATED APPLICATION

This application claims priority to U.S. Provisional Application Serial No. 63/755,936 filed on Feb. 7, 2025.

### TECHNICAL FIELD

The embodiments relate to electromechanical brakes for a motor vehicle and a method for controlling electromechanical brakes.

### BACKGROUND

Brakes are commonly used in vehicles to decelerate these in a targeted manner. Such brakes have hitherto in most cases been hydraulically actuated. The future trend for automotive braking systems is to eliminate hydraulic fluid. The next generation non-hydraulic brakes will be electro-magnetic. Whereby an electric motor will provide the brake forces. Like the hydraulic systems, a friction material will be pressed onto a rotating rotor or drum surface. There will also be transition period where both hydraulic and non-hydraulic systems are used together. However, in time, the vacuum booster, master cylinder, pedal with a connection thru the firewall, and hydraulic ABS modulator will become obsolete.

Electro-magnetic calipers or drums (EMBs) will then be directed by a controller(s) via electrical wires. Therefore, there will not be a physical mechanical connection between the brake pedal and the brakes. This will allow new features, as the brake pedal is separated from the corner brakes (brake by wire). For example, the driver may depress the brake pedal slightly whereby the driver is requesting a small amount of deceleration, whereby all four brakes would not necessarily have to actuate, the deceleration could be provided by only two brakes. Some of these strategies were possible with hydraulic systems using hydraulic modulator activities, but the EMBs will open up this potential much further, without having to actuate valves, or restricting hydraulic pressure, etc.

When hydraulic brakes were standard, and before ABS was available, a proportioning valve was inserted between the front axle and rear axle brakes. This prop valve would proportion the brake pressure between the front axle and rear axle mechanically. The design would insure during braking on high mu, that the rear axle wheels did not lock up before the front axle. This was done for vehicle stability during braking. However, the mechanical design did not compensate for differences in vehicle weight or other changes in the vehicle or brake system.

With adoption of ABS systems, the mechanical proportioning valve was removed, and the ABS system provided the front to rear brake proportioning. ABS systems were more efficient and flexible; especially to changes in vehicle weight. The ABS based proportioning would allow the same pressure into the front and rear calipers then observe the individual wheel behavior and modulate the rear axle pressure accordingly. For example, if the rear wheels began to slip, the rear axle brake pressure was held, or decreased, preventing vehicle instability.

As ABS systems evolved, including with the use of ESP sensors, more EBS features were developed. For example, there are EBS based features that help decrease lateral brake pull during base braking. These features were not normally implemented. If implemented, numerous conditions had to be met to activate, and then brake pressure was slowed and limited into one front wheel to slow the vehicle pull. Limiting brake pressure in a hydraulic EBS system has to be done using valves, as there are generally two calipers on each hydraulic circuit. Limiting hydraulic pressure increases the risk of brake system related noise, changes in the brake pedal, and causes more system and safety analysis. For example, ABS based rear proportioning can utilize an NVH feature which potentially sacrifices braking efficiency to reduce: ABS valve clicks, brake pedal movement, and other brake system noises.

The future trend for automotive braking systems is to eliminate hydraulic fluid. Future brake systems will use electro-magnetic brakes (EMB). Therefore, there will not be a physical mechanical connection between the brake pedal and the brake calipers.

### SUMMARY

A disclosed example method of controlling a vehicle brake system to which a plurality of wheel brakes are connected includes, among other possible things, determining a braking demand request from an input device; determining an application force for an actuator for each of the plurality of brakes; and controlling an actuator for each one of the plurality of brakes to selectively modulate the application force to a respective rotor of the one of the plurality of brakes, wherein the modulated application force is different from the application force to at least another rotor of the plurality of brakes to provide dynamic brake biasing to the one of the plurality of wheel brakes while ensuring adequate braking of the vehicle.

In another example embodiment of the foregoing method, modulating the application force to the respective one of the plurality of rotors further includes modulating at least one of timing and a strength of the application force.

In another example embodiment of any of the foregoing methods, the input device is a brake pedal.

In another example embodiment of any of the foregoing methods, modulating the application force to the respective one of the plurality of rotors further includes at least one of increasing and decreasing the application force to compensate for brake lining wear.

In another example embodiment of any of the foregoing methods, at least one of increasing and decreasing the application force to compensate for brake lining wear on the respective rotor further includes compensating for an amount of brake lining particulates produced by the respective one of the plurality of brakes during a braking operation.

In another example embodiment of any of the foregoing methods, including at least one of increasing and decreasing the application force further includes compensating for a brake rotor durability value of the respective one of the plurality of brakes.

In another example embodiment of any of the foregoing methods, at least one of increasing and decreasing the application force further includes compensating for an amount of rust on a brake rotor of the respective one of the plurality of brakes.

In another example embodiment of any of the foregoing methods, at least one of increasing and decreasing the application force further includes compensating for an amount of brake surface coating of the respective one of the plurality of brakes.

In another example embodiment of any of the foregoing methods, modulating the application force to the respective one of the plurality of rotors further includes at least one of increasing and decreasing the application force to compensate for tire tread wear on a respective tire associated with the respective one of the plurality of brakes.

In another example embodiment of any of the foregoing methods, modulating the application force to the respective one of the plurality of rotors further includes at least one of increasing and decreasing the application force to compensate for brake temperature for the respective one of the plurality of brakes.

In another example embodiment of any of the foregoing methods, wherein at least one of increasing and decreasing the application force to compensate for brake temperature for the respective one of the plurality of brakes further includes compensating for at least one of: brake fade and to increase a brake lining temperature.

In another example embodiment of any of the foregoing methods, wherein at least one of increasing and decreasing the application force to compensate for brake temperature for the respective one of the plurality of brakes further includes increasing the brake lining temperature to melt ice on the brake lining.

In another example embodiment of any of the foregoing methods, modulating the application force to the respective one of the plurality of rotors further includes at least one of increasing and decreasing the application force to compensate for a vehicle yaw that is independent of a steering angle.

In another example embodiment of any of the foregoing methods, modulating the application force to the respective one of the plurality of rotors further includes at least one of increasing and decreasing the application force to compensate for a longitudinal acceleration signal of the vehicle when a wheel speed of the vehicle is zero.

A disclosed example device for controlling a vehicle brake system to which a plurality of wheel brakes are connected according to another example embodiment of this disclosure includes, among other possible things, one or more processors configured to determine a braking demand request from an input device determine an application force for an actuator for each of the plurality of brakes, and control an actuator for each one of the plurality of brakes to selectively modulate the application force to a respective rotor of the one of the plurality of brakes, wherein the modulated application force is different from the application force to at least another rotor of the plurality of brakes to provide dynamic brake biasing to the one of the plurality of wheel brakes while ensuring adequate braking of the vehicle.

In another example embodiment of the forgoing device for controlling a vehicle brake system, the one or more processors are configured to modulate at least one of a timing and a strength of the application force.

In another example embodiment of any of the forgoing devices for controlling a vehicle brake system to which a plurality of wheel brakes, the input device is a brake pedal.

In another example embodiment of any of the forgoing devices for controlling a vehicle brake system to which a plurality of wheel brakes, when modulating the application force to the respective one of the plurality of rotors, are configured to at least one of increase and decrease the application force to compensate for brake lining wear on the respective rotor.

In another example embodiment of any of the forgoing devices for controlling a vehicle brake system, the at least one processor is further configured to compensate for an amount of brake lining particulates produced by the respective one of the plurality of brakes during a braking operation.

In another example embodiment of any of the forgoing devices for controlling a vehicle brake system to which a plurality of wheel brakes, the one or more processors are configured to compensate for a brake rotor durability value of the respective one of the plurality of brakes.

In another example embodiment of any of the forgoing devices for controlling a vehicle brake system to which a plurality of wheel brakes, the one or more processors are configured to compensate for an amount rust on a rotor of the respective one of the plurality of brakes.

In another example embodiment of any of the forgoing devices for controlling a vehicle brake system to which a plurality of wheel brakes, the one or more processors are configured to compensate for an amount brake surface coating of the respective one of the plurality of brakes.

In another example embodiment of any of the forgoing devices for controlling a vehicle brake system to which a plurality of wheel brakes, the one or more processors are configured to at least one of increase and decrease the application force to compensate for tire tread wear on a respective tire associated with the respective one of the plurality of brakes.

In another example embodiment of any of the forgoing devices for controlling a vehicle brake system to which a plurality of wheel brakes, the one or more processors are configured to at least one of increase or decrease the application force to compensate for brake temperature for the respective one of the plurality of brakes.

In another example embodiment of any of the forgoing devices for controlling a vehicle brake system to which a plurality of wheel brakes, the one or more processors are further configured to at least one of increase and decrease the application force to compensate for brake temperature for the respective one of the plurality of brakes and further to compensate for at least one of brake fade and an increase a brake line temperature.

In another example embodiment of any of the forgoing devices for controlling a vehicle brake system to which a plurality of wheel brakes, the one or more processors are further configured to at least one of increase and decrease the application force to compensate for brake temperature for the respective one of the plurality of brakes and further includes increasing the brake lining temperature to melt ice on the brake lining.

In another example embodiment of any of the forgoing devices for controlling a vehicle brake system to which a plurality of wheel brakes, the one or more processors are configured to at least one of increase and decreasing the application force to compensate for a vehicle yaw that is independent of a steering angle.

In another example embodiment of any of the forgoing devices for controlling a vehicle brake system to which a plurality of wheel brakes, the one or more processors are configured to at least one of increase and decreasing the application force to compensate for a longitudinal acceleration signal of the vehicle when a wheel speed of the vehicle is zero.

These and other features disclosed herein can be best understood from the following specification and drawings, the following of which is a brief description.

### BRIEF DESCRIPTION OF THE DRAWINGS

Further features and variations will be gathered by a person skilled in the art from the exemplary embodiment described below with reference to the appended drawing, in which:

FIG. 1 illustrates a schematic view of a brake system for a motor vehicle; and

FIG. 2 illustrates an embodiment of a method for operating a brake system.

### DETAILED DESCRIPTION

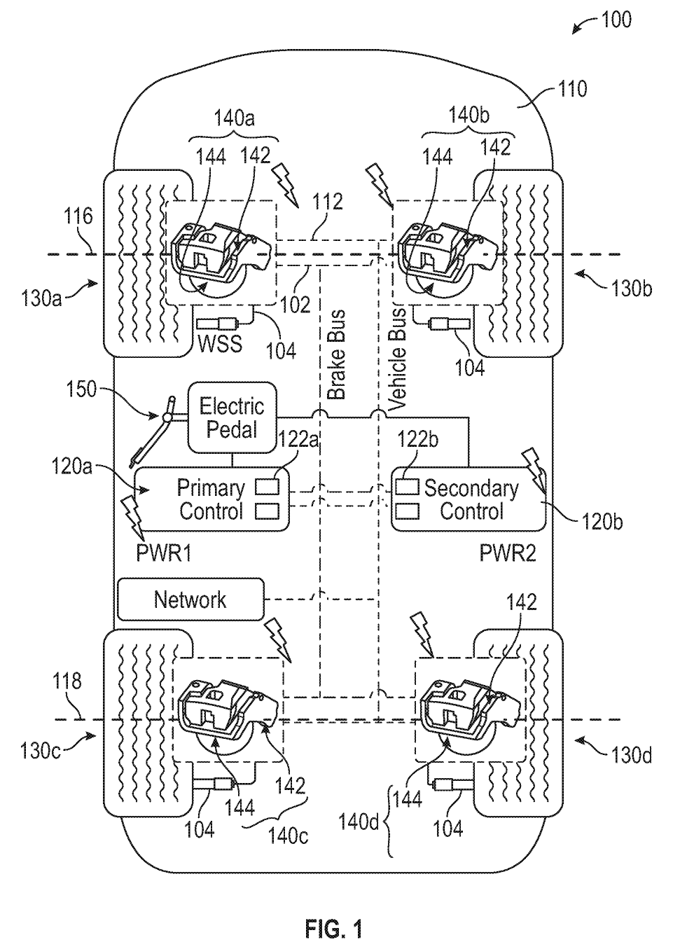

With reference to FIG. 1, a vehicle electronic brake system is shown, generally indicated at 100, in accordance with an embodiment. The electronic brake system 100 is located in a vehicle 110.

The brake system 100 includes first and second controllers 120a,b, a plurality of corner units 130 a, b, c, d located at corners of the vehicle 110. Each of the corner units 130 have an electro-mechanical brake (EMB) assembly 140 a, b, c, d, which include an actuator 142, i.e., a caliper and rotor a 144. The term EMB caliper and rotor are used generically to reference the brake actuator (caliper, or drum spread actuator) and rotor or exterior drum. The term lining is also used generically and interchangeably with friction material, lining, and pad.

Additionally, the brake system 100 includes an input device 150, for example an electronic pedal as shown schematically in FIG. 1. The input device 150 may be electronically connected the first and second controller 120 a, b to provide a “brake-by-wire” braking system. The input device 150 may further be part of an autonomous vehicle operating system that does not require drive input. In such an example, a vehicle controller would provide the braking input to initiate brake operation and actuation. Moreover, although an example input device 150 is disclosed by way of example, other input devices and methods may be utilized to initiate operation of the brake system 100 and are within the contemplation and scope of this disclosure.

The input device 150, first and second controllers 120a, b and the brake assemblies 140a-d may be electronically connected to one another via a brake bus 102 and also further, possibly redundantly, connected to a vehicle bus 112 for communication with each other and various vehicle systems.

The first controller 120a may be associated as the primary controller of the corner units 130a, b, associated with a front axle 116 of the vehicle 102 while the second controller 120b may be associated as the primary controller of the corner units 130 c, d, associated with a rear axle 118 of the vehicle 102. Each of the controllers 120a, 120b may also act as a redundant controller for the corner units 130 associated with the opposite axle. Alternatively, each corner unit 103 may have a separate controller 120. For example, the first controller and second controller 120a, b may each have multiple circuits that independently control each of the corner units 130. Regardless, each of the corner units 130 can be operated independently from one another using individual control strategies as explained in further detail below.

As shown in FIG. 1, the components of the brake system 100 may be part of a brake system modulator or control unit 120 that includes a processor circuit(s) 122. When the driver brakes (actuates brake pedal 150), the controller generates an electrical actuation signal for the associated corner unit 130. Then, the actuator 142, as controlled by the control unit 120 a, b, will supply the actual braking force to the rotors 144 associated with each brake. Future brake systems will have individually controlled EMB brakes (calipers and drums).

Brake biasing for different conditions are implemented with differently with an EMB system 100, relative to hydraulic systems. The example electric braking systems 100 provides brake biasing that is dynamically adjusted as vehicle operating parameters change. Additionally, each brake assembly can be adjusted individually from one another. The brake assemblies 140 can also be adjusted on a by axle basis, or based on side of the vehicle, such as to compensate for yaw conditions. For example, on a highway exit there may be a need to adjust the front and rear wheel brakes differently from one another, and the left and right brakes differently from one another. In such operating conditions, all brake assemblies 140 a-d may be modulated differently from one another. Conditions like vehicle loading, trailering, tire condition, driving angle, pitch, and many other parameters can be used to prompt dynamically changing the brake force biasing for the best possible braking performance. Use of various vehicle sensors 104 can be used to predict the desired brake demand rather than waiting and responding to conditions such as wheel slip.

The biasing for dry brakes is done by a central computing platform. This platform could have access to an array of vehicle data from various sensors 104, including those listed above and more (like ride height) and provide information utilized to dynamically change the brake force biasing based on the additional data. Dynamic application of brake force provides torque control at each corner to optimize braking performance.

The brake pedal 150 is separated from the corner brakes (brake by wire). In one example embodiment, the driver may lightly depress the brake pedal 150 to request vehicle to decelerate. However, all four brake assemblies 140a-d would not necessarily have to actuate. Instead, the example system 100 provides for the desired deceleration with brake force application with only two of the plurality of brake assemblies 140a-d.

The example brake assembly 100 dynamically distributes brake torque front to rear, laterally side to side, and to individual brake assemblies 140a-d. In the disclosed brake system 100 with EMBs brake biasing can be provided in a more dynamic and detailed manner. Additionally, dynamic brake biasing can also be used to help equalize brake lining wear, equalize tire wear, correct deceleration during failed caliper situations, etc.

The disclosed braking system 100 operates to provide braking force application bias strategies and methods to recognize when to bias the application of braking forces. The example braking system 100 provides for the bias application of braking forces to enable compensation for uneven brake lining wear, compensation for brake lining particulates, and compensation for uneven tire wear. The example braking system 100 may also provide compensation for caliper robustness to accommodate differences in brake design durability cycles. The brake system 100 may be configured to compensate for brake noise, vibration, and harshness. The brake system 100 may further enable compensation for individual brake temperatures to prevent brake fade or warm up brakes to operating temperatures. The brake system 100 may further provide for biased application of brake forces to compensate for side to side vehicle pull due to steering mis-alignment or current operating conditions. The example brake system 100 may further compensate for a failed caliper by increasing braking forces on other brake assemblies. The example system 100 may further compensate for wear and corrosion due to periods of non-activity. The example brake system 100 may further operate to compensate for brake rotor surface coatings such as may be present during initial operation of a new vehicle. The example brake system 100 may further function to compensate for water on brake rotor. The example brake system 100 may further operate to obtain a desired lining temperature to improve brake operation in extreme cold conditions. The example brake system 100 may further operate to provides hill hold function, and to provide improved vehicle stability be proportioning braking forces between different locations on the vehicle.

Each of the brake assemblies 140 are directed individually due to the absence of limitations present in hydraulic brake system. The example brake system 100 decouples any inherent interrelated connection between the individual calipers. Accordingly, when the driver depresses the brake pedal, they are expecting a certain amount of vehicle deceleration (via brake clamp forces, which results in brake torques). The driver does not have an indication of how the brake torque is supplied amount the brake assemblies 140. For example, if the driver depresses the brake pedal and requests low deceleration, if the brakes on only one axle, front or rear are actuated, there is no offset force on the vehicle. Therefore, the vehicle will not yaw from the braking, and the driver would not know that only one axle was braking.

If there is a different overall brake torque on one side of the vehicle relative to the other side of the vehicle, a force offset to the centerline may be applied to the vehicle by way of the example brake system 100. The offset and bias in the application of brake force generates a moment or torque on the vehicle, which causes the vehicle to yaw, and the steering would have to be compensated to keep a straight line. The size of the differential torque determines the vehicle’s yaw rate and how much the driver would have to compensate with the steering wheel. At lower decelerations (lower brake forces) the vehicle pull from the unbalanced brake forces may not be noticeable to the driver.

Dynamic brake biasing is provided by the example brake system 100 by changing the braking force application amounts at different corners of the vehicle 110. Moreover, brake noises may be reduced by the biased brake force application.

For example, in response to the front axle brake making noises from forces applied between 2000N to 2500N, an extra braking force of about 500N greater may be applied to the rear axle brake assemblies 140c, d. In one disclosed example, if a desired brake pressure is increased by continued application of force on the brake pedal, after a brake force of around 2500N, brake force on the front axle is phased up to 2500N and at the same time the extra braking force may be reduced at the rear axle brakes.

Accordingly, the example disclosed brake system 100 dynamically biases braking forces to provides a desired and specific benefit. The brake system 100 operates to observe a specific vehicle operating condition and then prevents or reduces undesired operation by the application of braking forces tailored to the observed or detected operation. For example, utilizing dynamic brake biasing for brake temperature regulation; could be observed and mitigated once it is occurring (the front brake temperatures are hot) or used as preventative (if the current conditions remain the front brakes will get hot).

### Uneven Brake Lining Wear

In one example embodiment, the example brake system 100 provides dynamic brake biasing to address uneven brake lining wear. Dynamic brake proportioning is used to help equalize brake lining thicknesses by observing or modelling the brake lining thicknesses, or by preventing the lining thickness differences from occurring. The brake lining thickness cannot be increased once installed as its physical parameter. Normally the brake systems are engineered such that the brake pad wear is approximately the same front to rear axle. However, each vehicle is driven differently, some are never loaded; while other vehicles routinely have high payloads. Therefore, generally, the friction brake linings do not wear out perfectly at the same time. Accordingly, dynamic brake force biasing elongates periods between lining changes and reduces un-used lining material that is scrapped.

Brake lining thickness may be monitored by the EMB caliper internal movement, for example the brake pad thickness is determined by the initial position of the electrical motor and/or gear system. As the brake pad wears, friction material will be removed, and the initial position slowly changes. The brake lining thickness may also be monitored by a lining sensor or approximated by a model based on vehicle braking applies, and/or caliper apply forces, along with vehicle speed and other conditions.

In one disclosed example, the front axle may do more work than anticipated, and over time have more lining wear than the rear axle. Such uneven lining wear is compensated for by using the rear axle brake assemblies 140 c, d, to apply more braking force during a higher number of low longitudinal deceleration (decel) braking events. During these compensating braking events, braking forces applied at the rear axle brake assemblies 140 c, d, are increased relative to braking forces applied by the front axle brake assemblies 140a, b. During this braking operation, a higher percentage of overall baseline braking force and torque is applied to the rear brake assemblies 140 c, d and braking forces applied by the front brake assemblies 140a, b, on the front axle are decreased.

If the requested braking continues to increase beyond that that can be provided by the brake assemblies 140 c, d at the rear axle 118, braking force applied by the brake assemblies 140a, b at the front axle 116 is increased.

Similarly, the uneven bias of braking forces may be applied side to side. For example, if the vehicle is typically loaded heavily on the left side (driver side) and the brakes wear faster on the left side, the right side brake assemblies 140b, d could be operated to provide relatively greater braking forces. Additionally, biasing between the brake assemblies 140a-d, may be performed on an individual basis to compensate for uneven wear on one of the brake assemblies.

Brake lining thickness variation is also prevented by observing if brake design assumptions were not correct. For example, if the rear axle was designed and expected to be loaded 10% of any operating time but is actually loaded 90% of the time. Operation with the increased loads bias braking forces toward the rear axle as the rear axle would have a higher normal force and can do more braking than without a payload. However, such operation would not be consistent with the brake design, and the rear linings would wear faster than anticipated. Accordingly, the example brake system 100 provides for adjustment of braking force biasing on real time conditions and the brake force is biased to the lower weighted front axle, as the rear axle workload is higher than its design. The vehicle’s weight may also be sensed and utilized to determine a bias for the application of braking forces. The vehicle weight may be observed utilizing ride height sensors, seat load sensors, or wheel speed signals coupled with tire pressure sensors.

The dynamic braking operation enabled by the example brake system 100 provides for the of lining thicknesses to be designed and varied relative to packaging constraints, thermal considerations, caliper weight considerations, etc. Utilizing the dynamic brake force biasing, a reduced lining thickness may be utilized.

### Brake Usage for Particulates

In a second example embodiment, the example brake assembly 100 provides for dynamic brake proportioning to produce lower brake particulates. Brake particulates could be lower in number or a more favorable size when brake applications forces are tailored to vehicle operation. For example, if one of the front and rear axles produces less particulates, braking forces could be biased to use the axel that produces the least amount of brake particulates. Such a determination could be determined during the chassis and brake design phase and/or adapted during vehicle operation.

### Uneven Tire Wear

In another example embodiment of the brake system 100, dynamic brake proportioning is used to equalize tire thickness differences. Tire thickness may be observed to tailor operation to maintain uniform tire thickness between all of the vehicle tires. Alternatively, the brake system 100 may be operated to shift the application of braking forces to prevent the tread differences from occurring.

Tire wear may be approximated by models based on driving behavior. For example, if a driver proceeds along one route that includes braking into left corners or accelerating hard during right hand turns from stop signs, such driving habits may be accommodated by dynamic application of brake forces. Additionally, a model of vehicle operation could be utilized that uses information from wheel speed signals coupled with tire pressures to determine how brake forces are tailored during vehicle operation to reduce and/or prevent uneven tire wear.

In another example embodiment, if all of the tire pressures are the same, and the vehicle is moving straight, the tire speeds should all be the same with balanced vehicle weighting. However, if one tire is moving faster than other tires, there is something different such as a larger tire diameter indicating an increased thread thickness as compared to the other tires. Tires that are not rotated frequently may naturally wear differently from front to rear or side to side based on differences in weight, front axle and rear axle suspension set up, and differences in the driveline. The differences in thread wear may be detected and/or sensed using different information available aboard the vehicle, such as ride height sensors, seat load sensors, or wheel speed signals coupled with tire pressure sensors.

Dynamic brake biasing, for uneven tire wear compensation may be used in conjunction with any of the other compensation functions described in this disclosure.

### Caliper Robustness

In another embodiment of operation of the example brake system 100, the example brake system 100 provides dynamic brake proportioning of braking forces to improve caliper robustness. In systems where the rear calipers are specified to function for a predetermined number of cycles, and the front axle is of a different design that is specified to function for a different predetermined number of cycles, then braking forces can be biased for application of more frequent braking forces to the caliper with greatest number of cycles. The brake force biasing implementation may occur as a preventive measure over the entire operating life. Alternatively, brake force biasing may be implemented when nearing the end of the predetermined number of cycles to extend the operational life. Dynamic biasing may also be implemented if a caliper is determined to be operating outside of desired parameters. A number of braking cycles may be monitored for each caliper and used to adjust the application of braking forces. Additionally, the number of braking cycles could be ascertained during scheduled maintenance.

### Individual Brake NVH

In another embodiment, the dynamic brake system 100 may apply braking forces to address individual brake noise, vibration, and harshness (NVH) concerns. NVY concerns may includes brake “creep groan.” Creep groan is a frequent customer complaint and therefore efforts to minimize such NVH increases customer perception and satisfaction. Brake noises that are not related to creep groan can also be addressed by dynamic brake biasing, such as noises that are specific to the EMB system 100. For example, clicks or humming noises produced by the EMB caliper or system. The biasing could be based on NVH during vehicle design or based on real time conditions such as the vehicle’s window openings, or the vehicle’s stereo speaker fade/balance. In the case of window openings, assuming one side of the vehicle’s windows are open, the brakes on the opposite side could be biased to reduce NVH from the calipers closest to the open windows. The EMB noises could be measured during platform design or monitored real time with interior microphones. The gathered information is then utilized to create a braking schedule depending on sensed vehicle operation that corresponds to specific operation.

### Individual Brake Temperatures

In another embodiment, the example brake system 100 provides dynamic brake biasing to obtain and maintain brakes within a desired brake temperature range. For example, dynamic brake biasing is performed to preferentially warm up the brakes on one axle or the calipers individually. Generally, brake linings have an optimal working range, which is higher than ambient temperature. Relative to brake fade from high lining temperatures, dynamic brake strategies help prevent fade by biasing to brakes that are lower in temperature. Brake temperature are measured with sensors but may also be modelled based on the heating characteristic of a brake corner. The heating characteristics may correspond with specific brake operation such as application amplitude and length of application. Additional information may be utilized such as how fast the system cools based on the mass of the rotor and speed of the rotating tire.

### Vehicle Side to Side Pull

In another embodiment, the example brake system 100 provides dynamic brake biasing to accommodate vehicle lateral pull during braking. For example, dynamic brake biasing reduces the side to side pull of the vehicle during braking when the steering or suspension system is out of alignment. The vehicle alignment may be observed by the steering angle sensor, and/or with a yaw acceleration sensor, lateral acceleration sensor, wheel speed signals, or steering rack force sensor. The steering angle, yaw acceleration, lateral forces of the vehicle may be monitored during braking to determine the amount and extent of current vehicle pulling. The pulling may result in inappropriate yawing or require excessive steering compensation. The example brake system 100 compensates by applying brake forces to counteract the side to side pull. The application of braking forces may further be utilized to accommodate future braking that may require compensation.

### Failed Caliper Situations

In another embodiment of the brake system 100 dynamic brake biasing is used to compensate for failure of a caliper 142. Upon failure of a caliper 142, brake forces may be dynamically biased to compensate for the loss of applicable brake forces to maintain consistency of the deceleration and increased vehicle stability.

For example, dynamic brake biasing may be used if the rear left caliper failed. Braking forces applied using the front left caliper are increased to compensate for the loss of braking torque on the failed left rear. The compensation provided by the increased brake forces at other brake assemblies would maintain the brake pedal feel for a desired deceleration consistent relative to a normal operating system. Moreover, the compensation with braking forces at other brake assemblies 140 provide better stability in creating equal side to side brake torques by reducing the unbalanced braking torque. Compensation for the loss of a caliper may also be performed by the application of additional braking forces with the remaining functioning calipers.

### Brake Rotor Rust or Non-Use

In another embodiment, the brake system 100 provides dynamic brake biasing with the strategies detailed above, to systematically remove the brake rotor rust. For example, after sitting for a long period, the brake rotor may R Dynamic brake biasing is used to apply the brakes and remove the rust. Dynamic brake biasing is beneficial as the rust could be removed per axle with brake application on a specific axle, or via individual the rotors with individual caliper application. Such an operating strategy may be performed when the vehicle is moving during: driver braking applications, or during non-driver braking with caliper applies that do not influence the vehicle dynamically, whereby the passengers do not feel the uneven application of braking force. Such braking operation may also be beneficial for vehicles that do not apply the friction brakes often. For example, electric vehicles use regenerative braking and do not apply the friction brakes often. A model could approximate when there is potential rust build up on the rotors. The strategy could also be used as diagnostic to ensure that the brakes are still functioning correctly.

### Brake Rotor Surface Coating Elimination

In another embodiment, the example brake system 100 provides dynamic brake biasing with the strategies detailed above, to systematically remove the brake rotor surface coating. For example, some vehicles have a rotor surface coating applied during the production process. The surface coating prevents rust and looks more appealing to potential purchasers. The surface coating usually wears off after a certain number of miles. Operation to remove the coating may include observing the vehicle’s mileage to determine appropriate activation cycles. The surface coating may not be wanted by some drivers/systems as the braking surfaces are less consistent with the coating, and usually a little lower in surface friction. Dynamic brake biasing is beneficial as the surface coating may be removed per axle with brake application on a specific axle, or via individual rotors with individual caliper application. This operating strategy many be performed when the vehicle is moving during: driver braking applications, or during non-driver braking with caliper applies that do not influence the vehicle dynamically, whereby the passengers do not feel the applications.

### Brake Surface Water Elimination

In another embodiment, the example braking system 100 provides dynamic brake biasing with the strategies detailed above, to systematically remove the water on the brake rotor or between the lining and rotor. There is a legacy EBS hydraulic feature called Rainy Brake Support. The legacy feature observes the windshield wiper cycling and then applies the brakes lightly to remove water on the rotor surface. EMB dynamic braking operates to improve on the principle of the legacy feature. Dynamic brake biasing may be beneficial as water could be wiped per axle with brake application on a specific axle, or via individual corner EMB brake force application. This operating strategy may be performed when the vehicle is moving during: driver braking applications, or during non-driver braking with caliper applies that do not influence the vehicle dynamically, whereby the passengers do not feel the applications. The activation may occur based on windshield wipers or rain sensors. If desired, the brake application could be lengthened to heat up the linings and rotors, to help water evaporate easier.

### Brake Surface Desired Temperature

In another embodiment, the brake system 100 provides dynamic brake biasing with the strategies detailed above, to systematically bring the lining temperatures to a desired temperature, and/or remove ice on the brake rotor or brake lining. Linings and rotors with potential icy surfaces may be modelled using ambient temperature sensors, information from the internet, windshield wiper systems, etc. Dynamic braking may be used to increase the lining and rotor temperatures to remove the ice. Brake lining and rotor temperatures can be measured with sensors but are usually modelled based on the ambient temperature along with the heating characteristic of a caliper (apply amplitude, and length of apply) and cooling gradient how fast the system cools (usually based on speed of the rotating tire). Dynamic brake biasing may be beneficial as the lining temperatures could be increased with brake application on a specific axle, or via individual the rotors with individual caliper application. This strategy could be performed when the vehicle is moving during: driver braking applications, or during non-driver braking with caliper applies that do not influence the vehicle dynamically, whereby the passengers do not feel the applications.

### Improved Hill Hold

In another embodiment, the brake system 100 provides dynamic brake biasing with the strategies detailed above for Hill Hold features or Hill Start Assist (HAS) features. Operation of the HSA feature observes the longitudinal acceleration signal and wheel speed signals to determine the grade on which the vehicle is stopped. When on an appropriate grade, the brake system 100 briefly holds the brake force to allow the driver to transition to the accelerator pedal or clutch pedal. The momentary application of braking force prevents the vehicle from rolling backwards until appropriate propulsive torque is applied and the brake force is phased out. Dynamic brake biasing is beneficial as the front and rear calipers could be controlled independently. For example, if the vehicle were parked facing up hill, the rear axle brake could be biased as more weight would be on the rear axle. The individual application of brake forces may be smoother with the example brake system 100 as compared to a hydraulic braking system.

The example brake system provides dynamic biasing by application of braking forces at the rear brakes. Accordingly, less front axle braking forces are present that required phasing out when making the transition to forward propulsion, especially in a front wheel drive vehicle. Operation of the brake system 100 may also be beneficial when releasing the parking mechanism on a hill, as an axle could be biased appropriately to hold the vehicle as the parking mechanism is released.

Operation of the brake system 100 may also be beneficial when off-roading, whereby when the driver depresses the brake pedal requesting the vehicle to be held at static, the non-propulsion axle could be biased whereby the propulsion axle would have less braking, making the transition to positive acceleration easier. Such biased brake application may also be done across an axle such as during diagonal groove situations. The example brake system 100 with individual control may be used to make the braking to propulsion transitions smoother, such as when transitioning from lifted wheel to planted wheel, especially when using open differential drivelines.

### Rear Axle Brake Bias for Stability

Brake bias is dynamically important when the rear axle wheels “lock,” before the front axle wheels. Such locking of the rear wheels can create an unstable vehicle situation. When the rear wheels lock, the vehicle can be de-stabilized as the rear wheels lateral holding capability is decreased with increasing wheel slip. As a vehicle decelerates, the weight shifts towards the front axle. A vehicle’s weight shift increases as the deceleration increases. Assuming the brake forces are linear and linearly correspond front to rear axle such as in a normal hydraulic system, which utilizes fixed caliper sizes with the same pressure on all 4 corners, and assuming no brake pressure modulation, each vehicle has a deceleration value whereby the rear axle wheels will lock (stop spinning), before the front axle wheels. This deceleration point is called “z-critical.” Anti-lock braking systems address such operation by monitoring the vehicle’s wheel speeds, for rear wheel tire slip, and proactively preventing the rear wheels from locking before the front axle.

The example brake system 100 provides dynamic brake biasing could also be employed to prevent rear wheel lock up. The brake bias in hydraulic systems, is based on front to rear brake torques (which are fixed proportionally and based on caliper sizing, effective radius, and brake pad friction values) along with a vehicle’s weight transfer (vehicle’s weight balance, center of gravity, and vehicle suspension – effecting the vehicle pitch). Utilizing the example brake system 100, rear brake bias is not fixed. Rear brake bias can be changed for the loading situation or to address other vehicle operating conditions as explained and disclosed within the specification. For example, using load determination algorithms a vehicle’s load can be calculated. The algorithms could be based on acceleration to vehicle propulsion torque, or deceleration to brake torque or sensors such as air system height sensors. The load could then be used to determine the front to rear brake bias as a baseline then the wheel slip can be monitored for the fine tuning. Generally, higher loads will allow higher brake forces on the rear axle, as loads are usually placed in a bed or behind the front axle.

In general, changing the rear brake bias is not important dynamically at low decelerations. Nor is it important if the rear axle tires are not slipping (above a nominal amount). Utilizing significantly high brake bias to the rear axle, the vehicle may subjectively feel slightly different than with conventional forces between the front and rear axle. These factors would be considered during implementation.

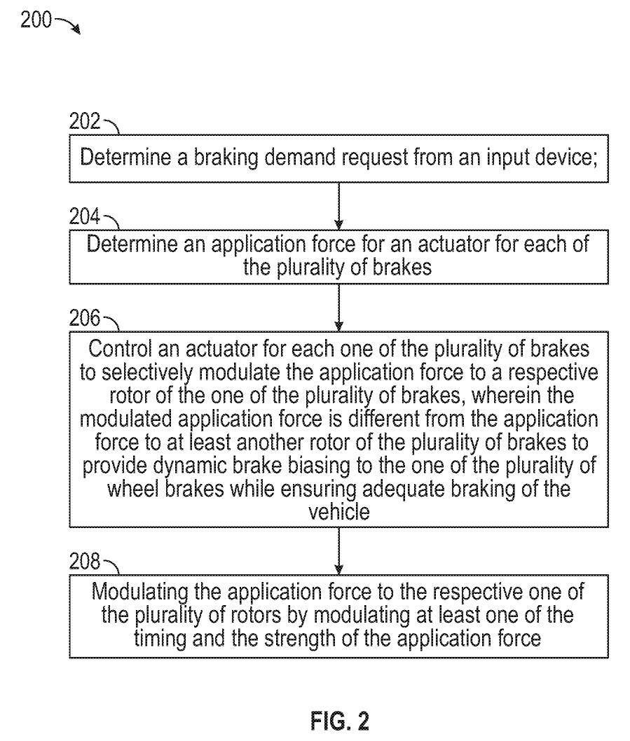

FIG. 2 is a flowchart of an example process 200. In some implementations, one or more process blocks of FIG. 2 may be performed by the example brake system 100.

As shown in FIG. 2, process 200 may include determining a braking demand request from an input device, step 202. Also, determining an application force for an actuator for each of the plurality of brakes, step 204. Further, controlling an actuator for each one of the plurality of brakes to selectively modulate the application force to a respective rotor of the one of the plurality of brakes, where the modulated application force is different from the application force to at least another rotor of the plurality of brakes to provide dynamic brake biasing to the one of the plurality of brakes, step 206.

The process 200 may further include modulating the application force to the respective one of the plurality of rotors further comprises modulating at least one of the timing and the strength of the application force.

For example, the controller 120 for the brake system 100 may determine a braking demand request from an input device; determining an application force for an actuator for each of the plurality of brakes; and controlling an actuator for each one of the plurality of brakes to selectively modulate the application force to a respective rotor of the one of the plurality of brakes, where the modulated application force is different from the application force to at least another rotor of the plurality of brakes to provide dynamic brake biasing to the one of the plurality of wheel brakes while ensuring adequate braking of the vehicle, as described above.

Process 200 may include additional implementations, such as any single implementation or any combination of implementations described below and/or in connection with one or more other processes described elsewhere herein. In a first implementation, modulating the application force to the respective one of the plurality of rotors further may include modulating at least one of the timing and the strength of the application force.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

Therefore, in general the embodiments illustrate various features as described in further details in the below disclosed example clauses.

Example Clause A: A method of controlling a vehicle brake system to which a plurality of wheel brakes are connected may include: determining a braking demand request from an input device; determining an application force for an actuator for each of the plurality of brakes; and controlling an actuator for each one of the plurality of brakes to selectively modulate the application force to a respective rotor of the one of the plurality of brakes, where the modulated application force is different from the application force to at least another rotor of the plurality of brakes to provide dynamic brake biasing to the one of the plurality of wheel brakes while ensuring adequate braking of the vehicle.

Example Clause B: The method of Example Clause A, where modulating the application force to the respective one of the plurality of rotors further may include modulating at least one of the timing and the strength of the application force.

Example Clause C: The method of Example Clause A or Example Clause B, where the input device is a brake pedal.

Example Clause D: The method of any one of Example Clauses A-C, where modulating the application force to the respective one of the plurality of rotors further may include at least one of increasing and decreasing the application force to compensate for brake lining wear on the respective rotor.

Example Clause E: The method of any one of Example Clauses A-D, where at least one of increasing and decreasing the application force to compensate for brake lining wear on the respective rotor further may include compensating for an amount of brake lining particulates produced by the respective one of the plurality of brakes during a braking operation.

Example Clause F: The method of any one of Example Clauses A-E, where at least one of increasing and decreasing the application force to compensate for brake lining wear on the respective rotor further may include compensating for a brake rotor durability value of the respective one of the plurality of brakes.

Example Clause G: The method of any one of Example Clauses A-F, where at least one of increasing and decreasing the application force to compensate for brake lining wear on the respective rotor further may include compensating for an amount brake lining dust of the respective one of the plurality of brakes.

Example Clause H: The method of any one of Example Clauses A-G, where at least one of increasing and decreasing the application force to compensate for brake lining wear on the respective rotor further may include compensating for an amount brake surface coating of the respective one of the plurality of brakes.

Example Clause I: The method of any one of Example Clauses A-H, where modulating the application force to the respective one of the plurality of rotors further may include at least one of increasing and decreasing the application force to compensate for tire tread wear on a respective tire associated with the respective one of the plurality of brakes.

Example Clause J: The method of any one of Example Clauses A-I, where modulating the application force to the respective one of the plurality of rotors further may include at least one of increasing and decreasing the application force to compensate for brake temperature for the respective one of the plurality of brakes.

Example Clause K: The method of any one of Example Clauses A-J, at least one of increasing and decreasing the application force to compensate for brake temperature for the respective one of the plurality of brakes further may include compensating for at least one of: brake fade and to increase a brake lining temperature.

Example Clause L: The method of any one of Example Clauses A-K, at least one of increasing and decreasing the application force to compensate for brake temperature for the respective one of the plurality of brakes further may include increasing the brake lining temperature to melt ice on the brake lining.

Example Clause M: The method of any one of Example Clauses A-L, where modulating the application force to the respective one of the plurality of rotors further may include at least one of increasing and decreasing the application force to compensate for a vehicle yaw that is independent of a steering angle.

Example Clause N: The method of any one of Example Clauses A-M, where modulating the application force to the respective one of the plurality of rotors further may include at least one of increasing and decreasing the application force to compensate for a longitudinal acceleration signal of the vehicle when a wheel speed of the vehicle is zero.

Example Clause O: A device for controlling a vehicle brake system to which a plurality of wheel brakes are connected may include: one or more processors configured to: determine a braking demand request from an input device determine an application force for an actuator for each of the plurality of brakes; and control an actuator for each one of the plurality of brakes to selectively modulate the application force to a respective rotor of the one of the plurality of brakes, where the modulated application force is different from the application force to at least another rotor of the plurality of brakes to provide dynamic brake biasing to the one of the plurality of wheel brakes while ensuring adequate braking of the vehicle.

Example Clause P: The device of Example Clause O, where the one or more processors, when modulating the application force to the respective one of the plurality of rotors, are configured to modulate at least one of the timing and the strength of the application force.

Example Clause Q: The device of Example Clause O or Example Clause P, where the input device is a brake pedal.

Example Clause R: The device of any one of Example Clauses O-Q, where the one or more processors, when modulating the application force to the respective one of the plurality of rotors, are configured to at least one of increase and decrease the application force to compensate for brake lining wear on the respective rotor.

Example Clause S: The device of any one of Example Clauses O-R, where the one or more processors, when at least one of increasing and decreasing the application force to compensate for brake lining wear on the respective rotor, are configured to compensate for an amount of brake lining particulates produced by the respective one of the plurality of brakes during a braking operation.

Example Clause T: The device of any one of Example Clauses O-S, where the one or more processors, when at least one of increasing and decreasing the application force to compensate for brake lining wear on the respective rotor, are configured to compensate for a brake rotor durability value of the respective one of the plurality of brakes.

Example Clause U: The device of any one of Example Clauses O-T, where the one or more processors, when at least one of increasing and decreasing the application force to compensate for brake lining wear on the respective rotor, are configured to compensate for an amount brake lining dust of the respective one of the plurality of brakes.

Example Clause V: The device of any one of Example Clauses O-U, where the one or more processors, when at least one of increasing and decreasing the application force to compensate for brake lining wear on the respective rotor, are configured to compensate for an amount brake surface coating of the respective one of the plurality of brakes.

Example Clause W: The device of any one of Example Clauses O-V, where the one or more processors, when modulating the application force to the respective one of the plurality of rotors, are configured to at least one of increase and decreasing the application force to compensate for tire tread wear on a respective tire associated with the respective one of the plurality of brakes.

Example Clause X: The device of any one of Example Clauses O-W, where the one or more processors, when modulating the application force to the respective one of the plurality of rotors, are configured to at least one of increase and decreasing the application force to compensate for brake temperature for the respective one of the plurality of brakes.

Example Clause Y: The device of any one of Example Clauses O-X, where the one or more processors are further configured to: at least one of increase and decreasing the application force to compensate for brake temperature for the respective one of the plurality of brakes further may include compensating for at least one of: brake fade and to increase a brake line temperature.

Example Clause Z: The device of any one of Example Clauses O-Y, where the one or more processors are further configured to: at least one of increase and decreasing the application force to compensate for brake temperature for the respective one of the plurality of brakes further may include increasing the brake lining temperature to melt ice on the brake lining.

Example Clause AA: The device of any one of Example Clauses O-Z, where the one or more processors, when modulating the application force to the respective one of the plurality of rotors, are configured to at least one of increase and decreasing the application force to compensate for a vehicle yaw that is independent of a steering angle.

Example Clause AB: The device of any one of Example Clauses O-AA, where the one or more processors, when modulating the application force to the respective one of the plurality of rotors, are configured to at least one of increase and decreasing the application force to compensate for a longitudinal acceleration signal of the vehicle when a wheel speed of the vehicle is zero.

The brakes in the disclosed embodiments provide increased brake performance along with more uniform brake lining wear, uniform tire wear, and brake system NVH improvements utilizing active features with electro-magnetic Brake systems.

Steps of the method that have been mentioned may be carried out in the order stated. They may however also be carried out in a different order if this is technically appropriate. In one of its embodiments, for example with a specific combination of steps, the method may be carried out in such a way that no further steps are carried out. In principle, however, further steps, even steps which have not been mentioned, may also be carried out.

Note that features may be described in combination in the claims and in the description, for example in order to facilitate understanding, even though said features may also be used separately from one another. A person skilled in the art will recognize that such features may also, independently of one another, be combined with other features or combinations of features.

Dependency references in dependent claims may characterize combinations of the respective features but do not exclude other combinations of features.

1. A method of controlling a vehicle brake system to which a plurality of wheel brakes are connected comprising:
determining a braking demand request from an input device;
determining an application force for an actuator for each of the plurality of brakes; and
controlling an actuator for each one of the plurality of brakes to selectively modulate the application force to a respective rotor of the one of the plurality of brakes, wherein the modulated application force is different from the application force to at least another rotor of the plurality of brakes to provide dynamic brake biasing to the one of the plurality of wheel brakes while ensuring adequate braking of the vehicle.

2. The method of claim 1, wherein modulating the application force to the respective one of the plurality of rotors further comprises modulating at least one of timing and a strength of the application force.

3. The method of claim 1, wherein the input device is a brake pedal.

4. The method of claim 1, wherein modulating the application force to the respective one of the plurality of rotors further comprises at least one of increasing and decreasing the application force to compensate for brake lining wear on the respective rotor.

5. The method of claim 4, further comprising compensating for an amount of brake lining particulates produced by the respective one of the plurality of brakes during a braking operation.

6. The method of claim 4, further comprising compensating for a brake rotor durability value of the respective one of the plurality of brakes.

7. The method of claim 1, further comprising compensating for an amount of rust on a brake rotor of the respective one of the plurality of brakes.

8. The method of claim 4, further comprising compensating for an amount brake surface coating of the respective one of the plurality of brakes.

9. The method of claim 1, wherein modulating the application force to the respective one of the plurality of rotors further comprises at least one of increasing and decreasing the application force to compensate for tire tread wear on a respective tire associated with the respective one of the plurality of brakes.

10. The method of claim 1, wherein modulating the application force to the respective one of the plurality of rotors further comprises at least one of increasing and decreasing the application force to compensate for brake temperature for the respective one of the plurality of brakes.

11. The method of claim 10, wherein modulating the application force to the respective one of the plurality of rotors further comprises compensating for at least one of brake fade or an increase in a brake lining temperature.

12. The method of claim 11, wherein modulating the application force to the respective one of the plurality of rotors further comprises increasing the brake lining temperature to melt ice on the brake lining.

13. The method of claim 1, wherein modulating the application force to the respective one of the plurality of rotors further comprises at least one of increasing and decreasing the application force to compensate for a vehicle yaw that is independent of a steering angle.

14. The method of claim 1, wherein modulating the application force to the respective one of the plurality of rotors further comprises at least one of increasing and decreasing the application force to compensate for a longitudinal acceleration signal of the vehicle when a wheel speed of the vehicle is zero.

15. A device for controlling a vehicle brake system to which a plurality of wheel brakes are connected comprising:
one or more processors configured to:
determine a braking demand request from an input device
determine an application force for an actuator for each of the plurality of brakes; and
control an actuator for each one of the plurality of brakes to selectively modulate the application force to a respective rotor of the one of the plurality of brakes, wherein the modulated application force is different from the application force to at least another rotor of the plurality of brakes to provide dynamic brake biasing to the one of the plurality of wheel brakes while ensuring adequate braking of the vehicle.

16. The device of claim 15, wherein the one or more processors, when modulating the application force to the respective one of the plurality of rotors, are configured to modulate at least one of a timing and a strength of the application force.

17. The device of claim 15, wherein the input device is a brake pedal.

18. The device of claim 15, wherein the one or more processors, when modulating the application force to the respective one of the plurality of rotors, are configured to perform at least one of increase or decreasing the application force to compensate for brake lining wear.

19. The device of claim 18, wherein the one or more processors are configured to compensate for an amount of brake lining particulates produced by the respective one of the plurality of brakes during a braking operation.

20. The device of claim 18, wherein the one or more processors are configured for increasing or decreasing the application force to compensate for a brake rotor durability value of the respective one of the plurality of brakes.

21. The device of claim 15, wherein the one or more processors are configured to compensate for an amount of rust on a rotor of the respective one of the plurality of brakes.

22. The device of claim 18, wherein the one or more processors are configured to compensate for an amount brake surface coating of the respective one of the plurality of brakes.

23. The device of claim 15, wherein the one or more processors are configured to increase or decrease the application force to compensate for tire tread wear on a respective tire associated with the respective one of the plurality of brakes.

24. The device of claim 15, wherein the one or more processors are configured to increase or decrease the application force to compensate for a brake temperature for the respective one of the plurality of brakes.

25. The device of claim 24, wherein the one or more processors are further configured to:
increase or decrease the application force to compensate for brake temperature for the respective one of the plurality of brakes and further comprises compensating for at least one of:
brake fade and increase a brake line temperature.

26. The device of claim 25, wherein the one or more processors are further configured to:
increase or decrease the application force to compensate for brake temperature for the respective one of the plurality of brakes and further comprises increasing the brake lining temperature to melt ice on the brake lining.

27. The device of claim 15, wherein the one or more processors are configured to at increase or decrease the application force to compensate for a vehicle yaw that is independent of a steering angle.

28. The device of claim 15, wherein the one or more processors are configured to at increase or decrease the application force to compensate for a longitudinal acceleration signal of the vehicle when a wheel speed of the vehicle is zero.
